(19) United States
(12) Patent Application Publication
(10) Pub. No.: US 2026/0176870 A1
(43) Pub. Date: Jun. 25, 2026

(54) FLEXIBLE FIBERS, CEMENTITIOUS MIXTURES COMPRISING FLEXIBLE FIBERS, AND BUILDING COMPONENTS FORMED THEREFROM

(71) Applicant: Indorama Ventures Hygiene Fibers, Inc., Duluth, GA (US)

(72) Inventors: Rachel Charlotte Severance, Lexington, SC (US); Bjørn Engelbrecht Pedersen, Esbjerg (DK)

(73) Assignee: Indorama Ventures Hygiene Fibers, Inc., Duluth, GA (US)

(21) Appl. No.: 19/427,347

(22) Filed: Dec. 19, 2025

Related U.S. Application Data
(60) Provisional application No. 63/736,664, filed on Dec. 20, 2024.

(51) Int. Cl. E04C 5/07; C04B 20/00; D01F 8/06; D06M 11/76

(52) U.S. Cl. CPC E04C 5/073; C04B 20/0048; D01F 8/06; D06M 11/76; D10B 2321/022; D10B 2401/08

(57) ABSTRACT

Flexible fibers, along with cementitious mixtures and building materials formed therefrom, are disclosed. In one aspect, a flexible fiber comprises a polymeric component and an inorganic component. In some embodiments, the surface of the flexible fiber comprises exposed pores. In some cases, at least some of the inorganic component is exposed on the surface of the flexible fiber. In some implementations, the polymeric component comprises a polyolefin. In some instances, the polyolefin comprises a polypropylene homopolymer or copolymer. In some embodiments, a linear density of the flexible fiber is from 0.5 decitex (dtex) to 50 dtex. In some cases, the flexible fiber has a length between 2 mm and 40 mm. In some implementations, the flexible fiber further comprises a foaming agent. In some instances, the inorganic component comprises calcium carbonate, silicon dioxide, titanium dioxide, talc, or a combination of two or more of the foregoing.

### CROSS REFERENCE TO RELATED APPLICATION

This application claims priority under 35 U.S.C. § 119 to U.S. Provisional Patent Application No. 63/736,664, filed Dec. 20, 2024, which is hereby incorporated by reference in its entirety.

### FIELD

This application relates to improved flexible fibers, along with cementitious (e.g., gypsum-containing) mixtures and building materials formed therefrom.

### BACKGROUND

Currently, gypsum-containing components are used to form boards used for walls, floors, and ceilings. Gypsum materials are typically a gypsum core that may be covered on each side by paper sheets. Gypsum panels are presently manufactured with various ingredients that impart particular properties, such as fire resistance. These fibrous ingredients are added to the gypsum slurry prior to coating with face papers. A major additive to gypsum materials is fiberglass. However, when the boards or panels flex, the fiberglass of the gypsum-containing materials causes the panel to fail. Moreover, the fiberglass does not bond strongly with the gypsum matrix itself, causing the pull-out strength of the fiberglass to be insufficient to maintain board integrity once breakage occurs. Thus, there is a need for improved additives for gypsum-containing mixtures.

### SUMMARY

In one aspect, flexible fibers are presented herein that may provide improved properties. In some cases, flexible fibers described herein may impart improved anchorage within cementitious mixtures, help to prevent fiber pull out, and/or improve material strength under mechanical stress.

In some embodiments, a flexible fiber described herein comprises a polymeric component and an inorganic component. In some cases, the surface of the flexible fiber comprises exposed pores. In some implementations, at least some of the inorganic component is exposed on the surface of the flexible fiber. In some instances, the polymeric component comprises a polyolefin. In some embodiments, the polyolefin comprises a polypropylene homopolymer or copolymer. In some cases, the inorganic component comprises calcium carbonate, silicon dioxide, titanium dioxide, talc, or a combination of two or more of the foregoing. In some implementations, the inorganic component may be present in an amount from 1 to 30 wt. %, based on the total weight of the fiber.

In some cases, the flexible fiber is a mono-component fiber. However, in some embodiments, the flexible fiber may comprise other components. Thus, in some cases, the flexible fiber is a bi-component fiber or a multi-component fiber or multiple component fiber. Moreover, in some cases, the flexible fiber may further comprise a foaming agent or voiding agent. In some implementations, the surface of the flexible fiber may further comprise a coating.

The linear density of the flexible fiber may be any linear density not inconsistent with the technical objectives of the current disclosure. In some implementations, the linear density of the flexible fiber is from 0.5 decitex (dtex) to 50 dtex. In some cases, the flexible fiber has a length between 2 mm and 40 mm. Moreover, the shape of the cross-section of flexible fiber is not limited. In some embodiments, the flexible fiber has a circular cross-section. However, in some embodiments, the flexible fiber has a non-circular cross-section shape. In some implementations, the cross-section may be a lobed shape or structure. In some instances, the cross-section comprises three lobes.

Flexible fibers described herein can be produced in any manner not inconsistent with the technical objectives of the present disclosure. Methods of making flexible fibers will be readily apparent to those skilled in the art. In some embodiments, the flexible fiber is formed using a physical foaming extrusion method or a chemical foaming extrusion method.

In another aspect, cementitious mixtures are presented herein. In some cases, a cementitious mixture described herein comprises a cementitious material and a flexible fiber described herein. Any flexible fiber described herein may be used. In some implementations, the cementitious material comprises gypsum.

In yet another aspect, building materials are described herein, including building materials formed from cementitious mixtures described herein. In some cases, the flexible fiber is present in the building material in an amount of 0.1 wt. % to 10 wt. %, based on the total weight of the material. In some implementations, the building material exhibits a maximum flexural strength between 600 and 1000 pounds as measured according to ASTM standard C348-02 with a modification of not using a tamper and tamper guide to make samples.

These and other embodiments are described in more detail in the detailed description which follows.

### BRIEF DESCRIPTION OF THE DRAWINGS

FIG. 1 is a photograph of a SEM image of the surface of a flexible fiber according to one embodiment described herein.

FIG. 2 is a photograph of a SEM image of a cross-section of a flexible fiber according to one embodiment described herein.

FIG. 3. is a photograph of a SEM image of a flexible fiber with a trilobal cross-section according to one embodiment described herein.

### DETAILED DESCRIPTION

Embodiments described herein can be understood more readily by reference to the following detailed description, examples, figures, and claims. Elements, apparatus, and methods described herein, however, are not limited to the specific embodiments presented in the detailed description, examples, and claims. In particular, these embodiments are merely illustrative of the principles of the present invention. Accordingly, this disclosure is not intended to embrace all such alternatives, modifications and variations that fall within the spirit and broad scope of the specification and in view of the claims.

All publications, patents and patent applications mentioned in this specification are herein incorporated in their entirety by reference into the specification, to the same extent as if each individual publication, patent, or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9. All ranges disclosed herein are also to be considered to include the end points of the range, unless expressly stated otherwise. For example, a range of “between 5 and 10,” “from 5 to 10,” or “5-10” should generally be considered to include the end points 5 and 10.

It is also to be understood that the article “a” or “an” refers to “at least one,” unless the context of a particular use requires otherwise.

In one aspect, flexible fibers, cementitious mixtures, and building materials are presented herein that may provide desirable properties. More particularly, in some cases, flexible fibers described herein may impart improved anchorage within cementitious mixtures, help to prevent fiber pull out, and/or improve material strength under mechanical stress.

### I. Flexible Fibers

In some embodiments, flexible fibers are described herein. In some embodiments, a flexible fiber comprises a polymeric component and an inorganic component. In some cases, the surface of the flexible fiber comprises exposed pores, channels, striations, and/or voids. In some implementations, at least some of the inorganic component is exposed on the surface of the flexible fiber.

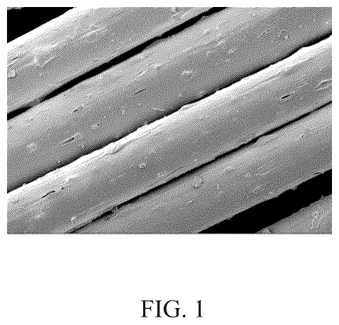

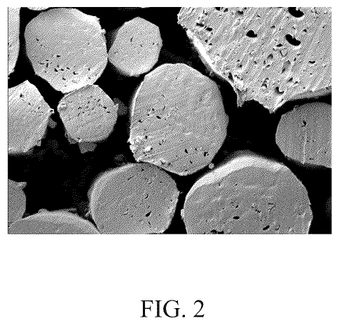

Regarding the flexible fibers described herein, it is to be understood for reference purposes herein, that in some cases, the term flexible indicates a fiber and/or a material that may be easily bent or folded. Moreover, in some embodiments, the surface of flexible fibers described herein is not smooth. That is, in some embodiments, the surface of the flexible fibers described herein is roughened and/or textured with pores, channels, striations, and/or voids. Thus, in some implementations, the surface of the flexible fiber comprises exposed pores, small channels, striations, and/or voids. It is also to be understood that in some implementations, during the formation of the flexible fiber, foaming and/or voiding techniques are used to induce the creation of or formation of pores, channels, striations, or voids on the surface of the fiber. FIG. 1 is a SEM image showing an exemplary embodiment of the exposed pores, channels, striations, or voids of the surface of the flexible fibers. Moreover, it is further to be understood that in some implementations, these pores, channels, or voids are embedded in the flexible fiber. FIG. 2 is a SEM image showing an exemplary embodiment of the pores, channels, striations, or voids of the flexible fibers embedded in the cross-section of the flexible fibers.

Any foaming and/or voiding technique not inconsistent with the technical objectives of the present disclosure may be used to form the pores, channels, striations, or voids. In some embodiments, chemical foaming may be used. In some cases, chemical foaming is performed using a chemical foaming agent. Moreover, in some implementations, physical foaming may be used. In some cases, physical foaming may occur via the introduction of air. In some instances, physical foaming may happen via a high shear rate during the formation of the fiber. Moreover, in some implementations, foaming techniques may be used to reduce the density of the flexible fibers as compared to the unfoamed material. In some cases, the density of the flexible fibers is reduced by 30%, 20%, 10%, or 5% as compared to the unfoamed material.

The pores, channels, striations and/or voids of flexible fibers described herein can have any size and/or shape not inconsistent with the technical objectives of the present disclosure. In some cases, the pore may have an elongated shape. Thus, in some implementations, the average length of the pores may be at least twice the average width or the average height of the pores. In some cases, the average length of the pores may be at least three times, at least four times, or at least five times the average width of the pores or the average height of the pores.

Additionally, the flexible fiber can have any linear density not inconsistent with the technical objectives of the present disclosure. In some cases, the linear density of the flexible fiber is from 0.5 decitex (dtex) to 50.0 dtex, 0.5 dtex to 40.0 dtex, 0.5 dtex to 30.0 dtex, 0.5 dtex to 20.0 dtex, 0.5 dtex to 11.0 dtex, 0.5 dtex to 4.0 dtex, 0.5 dtex to 3.0 dtex, 0.5 dtex to 1.0 dtex, 1.0 dtex to 50.0 dtex, 1.0 dtex to 40.0 dtex, 1.0 dtex to 30.0 dtex, 1.0 dtex to 20.0 dtex, 1.0 dtex to 11.0 dtex, 1.0 dtex to 4.0 dtex, 1.0 dtex to 3.0 dtex, 3.0 dtex to 50.0 dtex, 3.0 dtex to 40.0 dtex, 3.0 dtex to 30.0 dtex, 3.0 dtex to 20.0 dtex, 3.0 dtex to 11.0 dtex, 3.0 dtex to 4.0 dtex, 4.0 to 50.0 dtex, 4.0 dtex to 40.0 dtex, 4.0 dtex to 30.0 dtex, 4.0 dtex to 20.0 dtex, 4.0 dtex to 11.0 dtex, 11.0 to 50.0 dtex, 11.0 dtex to 40.0 dtex, 11.0 dtex to 30.0 dtex, 11.0 dtex to 20.0 dtex, 20.0 to 50.0 dtex, 20.0 dtex to 40.0 dtex, 20.0 dtex to 30.0 dtex, 30.0 to 50.0 dtex, 30.0 dtex to 40.0 dtex, or 40.0 to 50.0 dtex.

The flexible fiber can have any desired length not inconsistent with the technical objectives of the present disclosure. In some embodiments, the flexible fiber has a length between 2 mm and 40 mm, 2 mm and 30 mm, 2 mm and 20 mm, 2 mm and 18 mm, 2 mm and 16 mm, 2 mm and 14 mm, 2 mm and 12 mm, 2 mm and 10 mm, 2 mm and 8 mm, 8 mm and 40 mm, 8 mm and 30 mm, 8 mm and 20 mm, 8 mm and 18 mm, 8 mm and 16 mm, 8 mm and 14 mm, 8 mm and 12 mm, 8 mm and 10 mm, 10 mm and 40 mm, 10 mm and 30 mm, 10 mm and 20 mm, 10 mm and 18 mm, 10 mm and 16 mm, 10 mm and 14 mm, 10 mm and 12 mm, 12 mm and 40 mm, 12 mm and 30 mm, 12 mm and 20 mm, 12 mm and 18 mm, 12 mm and 16 mm, 12 mm and 14 mm, 14 mm and 40 mm, 14 mm and 30 mm, 14 mm and 20 mm, 14 mm and 18 mm, 14 mm and 16 mm, 16 mm and 40 mm, 16 mm and 30 mm, 16 mm and 20 mm, 16 mm and 18 mm, 18 mm and 40 mm, 18 mm and 30 mm, 18 mm and 20 mm, 20 mm and 40 mm, 20 mm and 30 mm, or 30 mm and 40 mm.

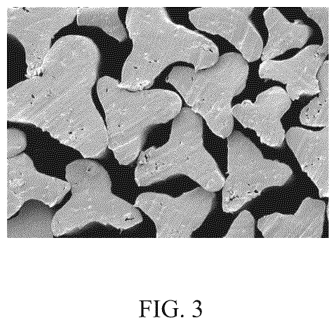

Moreover, the flexible fiber may have any morphology or shape not inconsistent with the technical objectives of the present disclosure. In some embodiments, the flexible fiber may have a circular cross-section. However, it is to be understood that in some cases, the flexible fiber may have a non-circular cross-section shape. In some cases, the cross-section shape may be an oval, a square, a rectangle, a polygon, or some other shape. Moreover, in some implementations, the cross-section may have or be a lobed shape or structure. In some embodiments, the cross-section comprises two lobes, three lobes, four lobes, or five lobes. FIG. 3 shows a SEM image of an exemplary embodiment of a fiber with a cross-section comprising three lobes.

In some implementations, flexible fibers described herein comprise a polymeric component. In some implementations, the polymeric component comprises, consists of, or consists essentially of a polyolefin. The identity of the polyolefin is not limited. However, in some embodiments, the polyolefin comprises, consists of, or consists essentially of a polypropylene homopolymer or copolymer. In some cases, the copolymer comprises a propylene-octene copolymer.

Additionally, it is to be understood that in some embodiments, the flexible fiber is a mono-component fiber. That is, in some cases, the flexible fiber comprises a single component or a single layer comprising the polymeric component. However, in some embodiments, the flexible fiber may also be a bi-component or a multi-component or multiple component fiber. In some cases, the flexible fiber may comprise a plurality of layers. However, it is to be understood that in some embodiments, the polymeric component forms the outermost layer. For example, in some implementations, a bi-component fiber may have an outer layer that is formed form, comprises, or consists essentially of the polymeric component and an inner layer core that is formed form, comprises, or consists essentially of a polymeric core. In some instances, the polymeric core may comprise the same material as the polymeric component. That is, in some embodiments, the polymeric core may comprise, consist of, or consist essentially of a polyolefin. In some cases, the polyolefin comprises, consists of, or consists essentially of a polypropylene homopolymer or copolymer. In some cases, the copolymer comprises a propylene-octene copolymer. However, in some implementations, the polymeric core may comprise, consist of, or consist essentially of other polymer materials. Non-limiting examples of other polymer materials include but are not limited to a polyester or a polyamide.

Additionally, in some implementations, in a multi-component fiber, again, it is to be understood that the polymeric component forms the outermost layer. In some cases, the multi-component fiber may comprise a plurality of layers. In some implementations, the multi-component fiber may have one or more layers between the polymeric component and the polymeric core. In some instances, one or more layers may be formed form, comprise, or consist essentially of the same material as the polymeric component. That is, in some embodiments, one or more layers may comprise, consist of, or consist essentially of a polyolefin. In some cases, the polyolefin comprises, consists of, or consists essentially of a polypropylene homopolymer or copolymer. In some cases, the copolymer comprises a propylene-octene copolymer. In some cases, one or more layers may comprise, consist of, or consist essentially of other polymer materials. Non-limiting examples of other polymer materials include but are not limited to a polyester or a polyamide.

Turning to other components of the flexible fiber, in some implementations, the flexible fiber further comprises a foaming agent. Any foaming agent not inconsistent with the technical objectives of the current disclosure may be used. In some cases, the foaming agent may be formed from or comprise a liquid. In some embodiments, the foaming agent may be formed from or comprise a particulate or a powder. In some instances, the foaming agent may be formed from or comprise a pellet or be in a pelleted form.

As previously discussed, it is to be understood that in some cases, the foaming agent comprises a chemical foaming agent (CFA) used to induce a foaming effect during the formation of the flexible fiber. In some implementations, a CFA comprises an endothermic CFA. For reference purposes herein, in some cases, an endothermic CFA comprises an agent that absorbs heat upon foaming. Non-limiting examples of endothermic CFAs include but are not limited to 4,4′-oxybis(benzenesulfonylhydrazide), the Alve-One line of endothermic CFAs from Solvay, and the TecoCell line of endothermic CFAs from Trexel Inc. In some embodiments, a CFA comprises a microcellular foaming agent.

In some cases, the CFA has an activation temperature. In some instances, the activation temperature of the CFA is between 180° C. and 250° C., 180° C. and 240° C., 180° C. and 230° C., 180° C. and 220° C., 180° C. and 210° C., 180° C. and 200° C., 180° C. and 190° C., 190° C. and 250° C., 190° C. and 240° C., 190° C. and 230° C., 190° C. and 220° C., 190° C. and 210° C., 190° C. and 200° C., 200° C. and 250° C., 200° C. and 240° C., 200° C. and 230° C., 200° C. and 220° C., 200° C. and 210° C., 210° C. and 250° C., 210° C. and 240° C., 210° C. and 230° C., 210° C. and 220° C., 220° C. and 250° C., 220° C. and 240° C., 220° C. and 230° C., 230° C. and 250° C., 230° C. and 240° C., or 240° C. and 250° C.

Further, the amount of CFA present may be any amount not inconsistent with the technical objectives of the present disclosure. In some cases, the CFA is present in amount between 0.1-5 wt. %, 0.1-4 wt. %, 0.1-3 wt. %, 0.1-2 wt. %, 0.1-0.5 wt. %, 0.5-5 wt. %, 0.5-4 wt. %, 0.5-3 wt. %, 0.5-2 wt. %, 1-5 wt. %, 1-4 wt. %, 1-3 wt. %, 1-2 wt. %, 2-5 wt. %, 2-4 wt. %, 2-3 wt. %, 3-5 wt. %, 3-4 wt. %, or 4-5 wt. %, based on the total weight of the fiber.

Moreover, in some embodiments, the surface of the flexible fibers described herein further comprises an inorganic component. In some cases, the inorganic component is exposed on the surface of the flexible fiber. In some implementations, all of the inorganic component present in the flexible fiber is exposed. In other implementations, a partial amount of the inorganic component present in the flexible fiber is exposed on the surface of the flexible fiber. That is, in some cases, at least some of the inorganic component is exposed on the surface of the flexible fiber. In some embodiments, at least 20%, 30%, 40%, 50%, 60%, or 70% of the total inorganic component is exposed on the surface of the flexible fiber.

The inorganic component used may be any material not inconsistent with the technical objectives of the present disclosure. In some embodiments, the inorganic component comprises, consists of, or consists essentially of calcium carbonate, silicon dioxide, titanium dioxide, talc, alum, calcium oxide, or combinations thereof.

Moreover, the amount of inorganic component present may be any amount not inconsistent with the technical objectives of the present disclosure. In some cases, the inorganic component is present in amount in the range of 1-30 wt. %, 5-30 wt. %, 10-30 wt. %, 15-30 wt. %, 20-30 wt. %, 25-30 wt. %, 1-25 wt. %, 5-25 wt. %, 10-25 wt. %, 15-25 wt. %, 20-25 wt. %, 1-20 wt. %, 5-20 wt. %, 10-20 wt. %, 15-20 wt. %, 1-15 wt. %, 5-15 wt. %, 10-15 wt. %, 1-10 wt. %, 5-10 wt. %, or 1-5 wt. %, based on the total weight of the fiber.

Additionally, in some implementations, the surface of the flexible fiber further comprises a coating and/or a finish. In some embodiments, the coating and/or a finish comprises a surfactant. In some embodiments, a coating and/or a finish comprises a hydrophilic coating.

Flexible fibers described herein may be produced in any manner not inconsistent with the technical objectives of the present disclosure. Methods of making flexible fibers will be readily apparent to those skilled in the art. Flexible fibers may be produced using extrusion and fiber spinning methods.

In some cases, the flexible fiber is formed using a chemical foaming extrusion method. Thus, in some embodiments, the CFA is added to the components of the flexible fiber in the hopper of the extruder. In some instances, the CFA is activated during the extrusion of the flexible fiber to form the pores, channels, striations, and/or voids of the flexible fibers.

In some embodiments, the flexible fiber is formed using a physical foaming extrusion method. Thus, in some implementations, during the production of the flexible fibers, gas is introduced into the polymer component to form “bubbles” that help to form the pores, channels, striations, and/or voids of the flexible fibers during extrusion. In some embodiments, the gas comprises air, nitrogen, hydrogen, carbon dioxide, oxygen, or a mixture of two or more of the foregoing.

Any extruder not inconsistent with the technical objectives of the current disclosure may be used. Many extruders will be readily apparent to those skilled in the art. For example, in some embodiments, a single screw extruder may be used. Non-limiting examples of single screw extruders include but are not limited to those extruders and extrusion systems provided by US Extruders, those extruders and extrusion systems provided by USEON, and those extruders and extrusion systems provided by LCI Corporation. In some cases, a single screw extruder comprises a barrier screw extruder.

In some embodiments, the components of flexible fiber described herein (i.e., the inorganic component, the polymer component, and/or foaming agent, if a foaming agent is used) are mixed in a hopper prior to entering the extrusion machinery. In some instances, the components of the flexible fiber are mixed at rotations per minute (rpm) in the range of 100 to 200 rpm, 100 to 180 rpm, 100 to 160 rpm, 100 to 140 rpm, 100 to 120 rpm, 120 to 200 rpm, 120 to 180 rpm, 120 to 160 rpm, 120 to 140 rpm, 140 to 200 rpm, 140 to 180 rpm, 140 to 160 rpm, 160 to 200 rpm, 160 to 180 rpm, or 180 to 200 rpm. The temperature at which the components of the flexible fiber are mixed may be any temperature not inconsistent with the technical objectives of the current disclosure. In some implementations, the temperature at which the mixing of the components of the flexible fiber occurs is in the range of 100-200° C., 100-190° C., 100-180° C., 100-170° C., 100-160° C., 100-150° C., 100-140° C., 100-130° C., 100-120° C., 100-110° C., 110-200° C., 110-190° C., 110-180° C., 110-170° C., 110-160° C., 110-150° C., 110-140° C., 110-130° C., 110-120° C., 120-200° C., 120-190° C., 120-180° C., 120-170° C., 120-160° C., 120-150° C., 120-140° C., 120-130° C., 130-200° C., 130-190° C., 130-180° C., 130-170° C., 130-160° C., 130-150° C., 130-140° C., 140-200° C., 140-190° C., 140-180° C., 140-170° C., 140-160° C., 140-150° C., 150-200° C., 150-190° C., 150-180° C., 150-170° C., 150-160° C., 160-200° C., 160-190° C., 160-180° C., 160-170° C., 170-200° C., 170-190° C., 170-180° C., 180-200° C., 180-190° C., or 190-200° C.

In some implementations, the path of the material within the extruder is divided into a plurality of zones. In some cases, an extruder may have 3 zones, 4 zones, 5 zones, 6 zones, or 7 zones. In some embodiments, the material first moves through a feed zone. In some instances, a feed zone is a first zone. In some cases, a feed zone is not a first zone, and a first zone is a subsequent zone. The temperature of the feed zone of the extruder may be any temperature not inconsistent with the technical objectives of the current disclosure. In some implementations, the temperature of the feed zone of the extruder is in the range of 150-200° C., 150-190° C., 150-180° C., 150-170° C., 150-160° C., 160-200° C., 160-190° C., 160-180° C., 160-170° C., 170-200° C., 170-190° C., 170-180° C., 180-200° C., 180-190° C., or 190-200° C. In some embodiments, the temperature of the feed zone is set at the activation temperature of the chemical foaming agent. In some cases, the temperature of the feed zone of the extruder is set below the activation temperature of the chemical foaming agent.

In some embodiments, an extruder may have a first zone. The temperature of the first zone of the extruder may be any temperature not inconsistent with the technical objectives of the current disclosure. In some embodiments, the temperature of the first zone is in the range of 100-200° C., 100-190° C., 100-180° C., 100-170° C., 100-160° C., 100-150° C., 100-140° C., 100-130° C., 100-120° C., 100-110° C., 110-200° C., 110-190° C., 110-180° C., 110-170° C., 110-160° C., 110-150° C., 110-140° C., 110-130° C., 110-120° C., 120-200° C., 120-190° C., 120-180° C., 120-170° C., 120-160° C., 120-150° C., 120-140° C., 120-130° C., 130-200° C., 130-190° C., 130-180° C., 130-170° C., 130-160° C., 130-150° C., 130-140° C., 140-200° C., 140-190° C., 140-180° C., 140-170° C., 140-160° C., 140-150° C., 150-200° C., 150-190° C., 150-180° C., 150-170° C., 150-160° C., 160-200° C., 160-190° C., 160-180° C., 160-170° C., 170-200° C., 170-190° C., 170-180° C., 180-200° C., 180-190° C., or 190-200° C. In some cases, the temperature of the first zone is set below the activation temperature of the chemical foaming agent. In some embodiments, the temperature of the first zone is set at the activation temperature of the chemical foaming agent. In some implementations, the temperature of the first zone exceeds the activation temperature of the chemical foaming agent.

In some embodiments, an extruder may have a second zone. The temperature of the second zone of the extruder may be any temperature that is not inconsistent with the objectives of the current disclosure. In some embodiments, the temperature of the second zone is in the range of 150-250° C., 150-240° C., 150-230° C., 150-220° C., 150-210° C., 150-200° C., 150-190° C., 150-180° C., 150-170° C., 150-160° C., 160-250° C., 160-240° C., 160-230° C., 160-220° C., 160-210° C., 160-200° C., 160-190° C., 160-180° C., 160-170° C., 170-250° C., 170-240° C., 170-230° C., 170-220° C., 170-210° C., 170-200° C., 170-190° C., 170-180° C., 180-250° C., 180-240° C., 180-230° C., 180-220° C., 180-210° C., 180-200° C., 180-190° C., 190-250° C., 190-240° C., 190-230° C., 190-220° C., 190-210° C., 190-200° C., 200-250° C., 200-240° C., 200-230° C., 200-220° C., 200-210° C., 210-250° C., 210-240° C., 210-230° C., 210-220° C., 220-250° C., 220-240° C., 220-230° C., 230-250° C., 230-240° C., or 240-250° C. In some cases, the temperature of the second zone is set below the activation temperature of the chemical foaming agent. In some embodiments, the temperature of the second zone is set at the activation temperature of the chemical foaming agent. In some implementations, the temperature of the second zone exceeds the activation temperature of the chemical foaming agent.

In some embodiments, an extruder may have a third zone. The temperature of the third zone of the extruder may be any temperature that is not inconsistent with the objectives of the current disclosure. In some instances, the temperature of the third zone is in the range of 220-320° C., 220-310° C., 220-300° C., 220-290° C., 220-280° C., 220-270° C., 220-260° C., 220-250° C., 220-240° C., 220-230° C., 230-320° C., 230-310° C., 230-300° C., 230-290° C., 230-280° C., 230-270° C., 230-260° C., 230-250° C., 230-240° C., 240-320° C., 240-310° C., 240-300° C., 240-290° C., 240-280° C., 240-270° C., 240-260° C., 240-250° C., 250-320° C., 250-310° C., 250-300° C., 250-290° C., 250-280° C., 250-270° C., 250-260° C., 260-320° C., 260-310° C., 260-300° C., 260-290° C., 260-280° C., 260-270° C., 270-320° C., 270-310° C., 270-300° C., 270-290° C., 270-280° C., 280-320° C., 280-310° C., 280-300° C., 280-290° C., 290-320° C., 290-310° C., 290-300° C., 300-320° C., 300-310° C., or 310-320° C. In some cases, the temperature of the third zone is set below the activation temperature of the chemical foaming agent. In some implementations, the temperature of the third zone is set at the activation temperature of the chemical foaming agent. In some cases, the temperature of the third zone exceeds the activation temperature of the chemical foaming agent.

In some embodiments, an extruder may have a fourth zone. The temperature of the fourth zone of the extruder may be any temperature that is not inconsistent with the objectives of the current disclosure. In some embodiments, the temperature of the fourth zone is in the range of 220-320° C., 220-310° C., 220-300° C., 220-290° C., 220-280° C., 220-270° C., 220-260° C., 220-250° C., 220-240° C., 220-230° C., 230-320° C., 230-310° C., 230-300° C., 230-290° C., 230-280° C., 230-270° C., 230-260° C., 230-250° C., 230-240° C., 240-320° C., 240-310° C., 240-300° C., 240-290° C., 240-280° C., 240-270° C., 240-260° C., 240-250° C., 250-320° C., 250-310° C., 250-300° C., 250-290° C., 250-280° C., 250-270° C., 250-260° C., 260-320° C., 260-310° C., 260-300° C., 260-290° C., 260-280° C., 260-270° C., 270-320° C., 270-310° C., 270-300° C., 270-290° C., 270-280° C., 280-320° C., 280-310° C., 280-300° C., 280-290° C., 290-320° C., 290-310° C., 290-300° C., 300-320° C., 300-310° C., or 310-320° C. In some cases, the temperature of the fourth zone is set below the activation temperature of the chemical foaming agent. In some embodiments, the temperature of the fourth zone is set at the activation temperature of the chemical foaming agent. In some implementations, the temperature of the fourth zone exceeds the activation temperature of the chemical foaming agent.

In some embodiments, an extruder may have a fifth zone. The temperature of the fifth zone of the extruder may be any temperature that is not inconsistent with the objectives of the current disclosure. In some embodiments, the temperature of the fifth zone is in the range of 220-320° C., 220-310° C., 220-300° C., 220-290° C., 220-280° C., 220-270° C., 220-260° C., 220-250° C., 220-240° C., 220-230° C., 230-320° C., 230-310° C., 230-300° C., 230-290° C., 230-280° C., 230-270° C., 230-260° C., 230-250° C., 230-240° C., 240-320° C., 240-310° C., 240-300° C., 240-290° C., 240-280° C., 240-270° C., 240-260° C., 240-250° C., 250-320° C., 250-310° C., 250-300° C., 250-290° C., 250-280° C., 250-270° C., 250-260° C., 260-320° C., 260-310° C., 260-300° C., 260-290° C., 260-280° C., 260-270° C., 270-320° C., 270-310° C., 270-300° C., 270-290° C., 270-280° C., 280-320° C., 280-310° C., 280-300° C., 280-290° C., 290-320° C., 290-310° C., 290-300° C., 300-320° C., 300-310° C., or 310-320° C. In some cases, the temperature of the fifth zone is set below the activation temperature of the chemical foaming agent. In some embodiments, the temperature of the fifth zone is set at the activation temperature of the chemical foaming agent. In some implementations, the temperature of the fifth zone exceeds the activation temperature of the chemical foaming agent.

In some embodiments, an extruder may have a sixth zone. The temperature of the sixth zone of the extruder may be any temperature that is not inconsistent with the objectives of the current disclosure. In some cases, the temperature of the sixth zone is in the range of 220-320° C., 220-310° C., 220-300° C., 220-290° C., 220-280° C., 220-270° C., 220-260° C., 220-250° C., 220-240° C., 220-230° C., 230-320° C., 230-310° C., 230-300° C., 230-290° C., 230-280° C., 230-270° C., 230-260° C., 230-250° C., 230-240° C., 240-320° C., 240-310° C., 240-300° C., 240-290° C., 240-280° C., 240-270° C., 240-260° C., 240-250° C., 250-320° C., 250-310° C., 250-300° C., 250-290° C., 250-280° C., 250-270° C., 250-260° C., 260-320° C., 260-310° C., 260-300° C., 260-290° C., 260-280° C., 260-270° C., 270-320° C., 270-310° C., 270-300° C., 270-290° C., 270-280° C., 280-320° C., 280-310° C., 280-300° C., 280-290° C., 290-320° C., 290-310° C., 290-300° C., 300-320° C., 300-310° C., or 310-320° C. In some instances, the temperature of the sixth zone is set below the activation temperature of the chemical foaming agent. In some embodiments, the temperature of the sixth zone is set at the activation temperature of the chemical foaming agent. In some implementations, the temperature of the sixth zone exceeds the activation temperature of the chemical foaming agent.

In some embodiments, an extruder may have a seventh zone. The temperature of the seventh zone of the extruder may be any temperature that is not inconsistent with the objectives of the current disclosure. In some instances, the temperature of the seventh zone is in the range of 220-320° C., 220-310° C., 220-300° C., 220-290° C., 220-280° C., 220-270° C., 220-260° C., 220-250° C., 220-240° C., 220-230° C., 230-320° C., 230-310° C., 230-300° C., 230-290° C., 230-280° C., 230-270° C., 230-260° C., 230-250° C., 230-240° C., 240-320° C., 240-310° C., 240-300° C., 240-290° C., 240-280° C., 240-270° C., 240-260° C., 240-250° C., 250-320° C., 250-310° C., 250-300° C., 250-290° C., 250-280° C., 250-270° C., 250-260° C., 260-320° C., 260-310° C., 260-300° C., 260-290° C., 260-280° C., 260-270° C., 270-320° C., 270-310° C., 270-300° C., 270-290° C., 270-280° C., 280-320° C., 280-310° C., 280-300° C., 280-290° C., 290-320° C., 290-310° C., 290-300° C., 300-320° C., 300-310° C., or 310-320° C. In some cases, the temperature of the seventh zone is set below the activation temperature of the chemical foaming agent. In some embodiments, the temperature of the seventh zone is set at the activation temperature of the chemical foaming agent. In some implementations, the temperature of the seventh zone exceeds the activation temperature of the chemical foaming agent.

Further, the pressure of the extruder may be any pressure that is not inconsistent with the objectives of the current disclosure. In some embodiments, the pressure of the extruder is between 80 and 130 bar, 80 and 120 bar, 80 and 110 bar, 80 and 100 bar, 80 and 90 bar, 90 and 130 bar, 90 and 120 bar, 90 and 110 bar, 90 and 100 bar, 100 and 130 bar, 100 and 120 bar, 100 and 110 bar, 110 and 130 bar, 110 and 120 bar, or 120 and 130 bar.

Moreover, the rpms of the extruder may be any rpms that is not inconsistent with the objectives of the current disclosure. In some instances, the extrusion of the flexible fibers occurs at 100-200 rpms, 100-190 rpms, 100-180 rpms, 100-170 rpms, 100-160 rpms, 100-150 rpms, 100-140 rpms, 100-130 rpms, 100-120 rpms, 100-110 rpms, 110-200 rpms, 110-190 rpms, 110-180 rpms, 110-170 rpms, 110-160 rpms, 110-150 rpms, 110-140 rpms, 110-130 rpms, 110-120 rpms, 120-200 rpms, 120-190 rpms, 120-180 rpms, 120-170 rpms, 120-160 rpms, 120-150 rpms, 120-140 rpms, 120-130 rpms, 130-200 rpms, 130-190 rpms, 130-180 rpms, 130-170 rpms, 130-160 rpms, 130-150 rpms, 130-140 rpms, 140-200 rpms, 140-190 rpms, 140-180 rpms, 140-170 rpms, 140-160 rpms, 140-150 rpms, 150-200 rpms, 150-190 rpms, 150-180 rpms, 150-170 rpms, 150-160 rpms, 160-200 rpms, 160-190 rpms, 160-180 rpms, 160-170 rpms, 170-200 rpms, 170-190 rpms, 170-180 rpms, 180-200 rpms, 180-190 rpms, or 190-200 rpms.

In some embodiments, the flexible fiber is a bi-component or a multi-component fiber. In such cases, the bi-component fiber or multi-component fiber is made by a coextrusion process in which the components are metered to a die or spinneret separately. Such a coextruded fiber can have a variety of morphologies including but not limited to sheath-core, side-by-side, islands in the sea, bilobal, trilobal, and pie-section.

In the sheath-core embodiment of the flexible fiber, in some instances, the polymeric component forms a sheath on the majority of the outside surface of the fiber. In some cases, the core may be centered in the fiber cross-section or may be off-center. In some instances, the sheath may cover the core in a complete fashion over the circumference of the fiber or may be only partially covering over the circumference of the fiber. In the case where the covering is partial about the circumference, the morphology is distinguished from side-by-side morphologies in that the core makes up the majority of the volume of the fiber. In some instances, the volume ratio of the sheath to the core may range from 1:99 to 50:50. In some embodiments, the range of sheath to core volume ratio may range from 5:95 to 40:60 or from 10:90 to 30:70. In some implementations, the sheath comprises a polymeric component, and the core comprises a polymeric core.

In an “islands-in-the-sea” embodiment of the flexible fiber, in some instances, the sea forms a continuous matrix in which the islands exist. The islands are referred to as such because of their appearance in cross-sectional views of the coextruded bi-component fiber. The islands are the polymer component embedded in the continuous sea matrix. In this embodiment, the sea consists primarily of the polymeric core, and the islands are comprised of the polymer component. The volume ratio of the sea to the islands may range from 1:99 to 50:50. In some cases, the volume ratio may range from 5:95 to 40:60 or from 10:90 to 30:70.

### II. Cementitious Mixtures

In another aspect, cementitious mixtures are described herein. In some embodiments, a cementitious mixture described herein comprises a cementitious material and a flexible fiber. Any flexible fiber described hereinabove in Section I may be used. For example, in some cases, the flexible fiber comprises a polymeric component and an inorganic component. In some embodiments, the surface of the flexible fiber comprises exposed pores, channels, striations, and/or voids. In some implementations, at least some of the inorganic component is exposed on the surface of the flexible fiber.

In some embodiments, the flexible fiber may be present in the cementitious mixture in any amount not inconsistent with the technical objectives of the present disclosure. In some embodiments, the flexible fiber is present in the cementitious mixture in an amount of 0.1 wt. % to 20 wt. %, 0.1 wt. % to 15 wt. %, 0.1 wt. % to 10 wt. %, 0.1 wt. % to 5 wt. %, 0.1 wt. % to 4 wt. %, 0.1 wt. % to 3 wt. %, 0.1 wt. % to 2 wt. %, 0.1 wt. % to 1 wt. %, 0.1 wt. % to 0.5 wt. %, 0.5 wt. % to 20 wt. %, 0.5 wt. % to 15 wt. %, 0.5 wt. % to 10 wt. %, 0.5 wt. % to 5 wt. %, 0.5 wt. % to 4 wt. %, 0.5 wt. % to 3 wt. %, 0.5 wt. % to 2 wt. %, 0.5 wt. % to 1 wt. %, 1 wt. % to 20 wt. %, 1 wt. % to 15 wt. %, 1 wt. % to 10 wt. %, 1 wt. % to 5 wt. %, 1 wt. % to 4 wt. %, 1 wt. % to 3 wt. %, 1 wt. % to 2 wt. %, 2 wt. % to 20 wt. %, 2 wt. % to 15 wt. %, 2 wt. % to 10 wt. %, 2 wt. % to 5 wt. %, 2 wt. % to 4 wt. %, 2 wt. % to 3 wt. %, 3 wt. % to 20 wt. %, 3 wt. % to 15 wt. %, 3 wt. % to 10 wt. %, 3 wt. % to 5 wt. %, 3 wt. % to 4 wt. %, 4 wt. % to 20 wt. %, 4 wt. % to 15 wt. %, 4 wt. % to 10 wt. %, 4 wt. % to 5 wt. %, 5 wt. % to 20 wt. %, 5 wt. % to 15 wt. %, 5 wt. % to 10 wt. %, 10 wt. % to 20 wt. %, 10 wt. % to 15 wt. %, or 15 wt. % to 20 wt. %, based on the total weight of the cementitious mixture before drying.

Turning to other components of cementitious mixtures described herein, in some embodiments, a cementitious mixture described herein comprises a cementitious material. In some cases, the cementitious material comprises, consists of, or consist essentially of gypsum. For reference purposes herein, gypsum comprises compounds comprising calcium sulfate (CaSO₄). In some cases, the amount of water of crystallization of the calcium sulfate can and does vary. In some embodiments, gypsum may comprise calcium sulfate anhydrite (CaSO₄), calcium sulfate hemihydrate (CaSO₄·½H₂O), or calcium sulfate dihydrate (CaSO₄·2H₂O). In some cases, calcium sulfate hemihydrate may be present in its alpha form or beta form. In some implementations, calcium sulfate anhydrite can be further categorized into I, II, and III forms. In some instances, gypsum may be natural gypsum or synthetic gypsum. Further, in some implementations, gypsum may comprise stucco. For reference purposes herein, stucco refers to calcined gypsum in the form of calcium sulfate hemihydrate and/or calcium sulfate anhydrite. Any form of gypsum not inconsistent with the technical objectives of this disclosure may be used.

Gypsum may be present in the cementitious mixture in various amounts. In some implementations, gypsum may be present in the cementitious mixture in an amount of at least 40 wt. %, 50 wt. %, 60 wt. %, 70 wt. %, 80 wt. %, 90 wt. %, or 95 wt. %, based on the total weight of the cementitious mixture. In some cases, gypsum may be present in an amount in the range of 40-95 wt. %, 40-90 wt. %, 40-80 wt. %, 40-80 wt. %, 40-70 wt. %, 40-60 wt. %, 40-50 wt. %, 50-95 wt. %, 50-90 wt. %, 50-80 wt. %, 50-70 wt. %, 50-60 wt. %, 60-95 wt. %, 60-90 wt. %, 60-80 wt. %, 60-70 wt. %, 70-95 wt. %, 70-90 wt. %, 70-80 wt. %, 80-95 wt. %, 80-90 wt. %, or 90-95 wt. %, based on the total weight of the cementitious mixture before drying.

Moreover, in some cases, a cementitious mixture described herein may further comprise a starch. In some instances, the starch used may be obtained from any suitable plant source. Non-limiting plant sources include but are not limited to tubers, tapioca, rice, or corn. In some cases, the starch may be a particulate powder. For example, the starch may comprise a flour or flour-like powder. Additionally, in some embodiments, the starch in the form of a particulate powder, flour, or flour-like powder may be mixed with the gypsum prior to being mixed with water in the preparation of the cementitious mixture. In contrast, in some cases, the starch in the form of a particulate powder, flour, or flour-like powder may be mixed with the gypsum at the same time it is mixed water in the preparation of the cementitious mixture.

Further, in some embodiments, the starch may be unmodified or chemically and/or enzymatically modified. In some implementations, the starch may be a pregelatinized starch. Any pregelatinized starch not inconsistent with the technical objectives of the present disclosure may be used. Non-limiting examples of pregelatinized starch include but are not limited to PCF 1000 starch, commercially available from Lauhoff Grain Company; and AMERIKOR 818 and HQM PREGEL starches, both commercially available from Archer Daniels Midland Company. Additionally, in some instances, the starch may be an acid-modified starch.

The starch may be present in the cementitious mixture in any amount not inconsistent with the technical objectives of the present disclosure. In some cases, the starch may be present in an amount in the range of 0.5-10 wt. %, 0.5-8 wt. %, 0.5-6 wt. %, 0.5-4 wt. %, 0.5-2 wt. %, 2-10 wt. %, 2-8 wt. %, 2-6 wt. %, 2-4 wt. %, 4-10 wt. %, 4-8 wt. %, 4-6 wt. %, 6-10 wt. %, 6-8 wt. %, or 8-10 wt. %, based on the total weight of the cementitious mixture before drying.

In some implementations, a cementitious mixture may further comprise water. It is to be understood, for reference purposes herein, that since dried cementitious mixtures are formed from a gypsum slurry comprising water and gypsum, the cementitious mixture has a “water-to-stucco” (“WSR”) ratio. In some instances, the notation for the WSR ratio is indicated as “XWSR” wherein X is the parts of water to 100 parts of gypsum by weight. Any WSR not inconsistent with the technical objectives of the present disclosure may be used. In some implementations, the WSR for a cementitious mixture before drying is between 40 WSR and 80 WSR, 40 WSR and 70 WSR, 40 WSR and 60 WSR, 40 WSR and 50 WSR, 50 WSR and 80 WSR, 50 WSR and 70 WSR, 50 WSR and 60 WSR, 60 WSR and 80 WSR, 60 WSR and 70 WSR, or 70 WSR and 80 WSR.

In some embodiments, a cementitious mixture described herein may also comprise one or more additives. Additives may be used in the manner and amounts known in the art. In some instances, additives are in solid, powder, or granular form and are added to the dry components before the slurry is mixed. Non-limiting examples of additives include but are not limited to cellulose ethers, slaked lime, plasticizers, hydrophobic agents, water reducing agents, mineral additives, low-density aggregates, fibers, accelerators, thickeners, set retardants, dry accelerators, air pore formers, additional foaming agents, swelling agents, fillers, polyacrylates, dispersants, superabsorbents, stabilizers, co-surfactants, biocides, anti-mold agents, and flame retardants.

Turning to specific additives, in some cases, an additive comprises a plasticizer. Any plasticizer not inconsistent with the technical objectives of the present disclosure may be used. Moreover, any amount of plasticizer not inconsistent with the technical objectives of the present disclosure may be used. For example, in some cases, a plasticizer may be present in an amount in the range of 0.01-2.0 wt. %, 0.01-1.0 wt. %, 0.01-0.5 wt. %, 0.01-0.1 wt. %, 0.1-2.0 wt. %, 0.1-1.0 wt. %, 0.1-0.5 wt. %, 0.5-2.0 wt. %, 0.5-1.0 wt. %, or 1.0-2.0 wt. %, based upon the total weight of the cementitious mixture before drying.

In some embodiments, an additive comprises a hydrophobic agent. Any hydrophobic agent not inconsistent with the technical objectives of the present disclosure may be used. Moreover, any amount of hydrophobic agent not inconsistent with the technical objectives of the present disclosure may be used. For example, in some cases, a hydrophobic agent may be present in an amount in the range of 0.5-1.0 wt. %, based upon the total weight of the cementitious mixture before drying.

In some implementations, an additive comprises a water reducing agent. Any water reducing agent not inconsistent with the technical objectives of the present disclosure may be used. For example, in some embodiments, a water reducing agent may comprise polynaphthalene sulfonate sodium salt. Moreover, any amount of water reducing agent not inconsistent with the technical objectives of the present disclosure may be used. For example, in some cases, a water reducing agent may be present in an amount in the range of 0.0005-1.0 wt. %, based upon the total weight of the cementitious mixture before drying.

In some instances, an additive comprises an additional foaming agent. It is to be understood that in some cases, this additional foaming agent may be different than the foaming agent used in the manufacture of the flexible fiber. Any foaming agent not inconsistent with the technical objectives of the present disclosure may be used. Non-limiting examples include but are not limited to the HYONIC line of soap products from GEO Specialty Chemicals. Additionally, in some embodiments, a foaming agent may comprise alpha-sulfo fatty acid disalt. Moreover, any amount of foaming agent not inconsistent with the technical objectives of the present disclosure may be used. For example, in some implementations, a foaming agent may be present in an amount in the range of 0.5-1.0 wt. %, based upon the total weight of the cementitious mixture before drying.

In some implementations, an additive comprises a set accelerator. Any set accelerator not inconsistent with the technical objectives of the present disclosure may be used. For example, in some embodiments, a set accelerator may comprise potassium sulfate. Additionally, other wet gypsum accelerators, such as those disclosed in U.S. Pat. No. 6,409,825, which is incorporated herein by reference, may be used. Further, in some cases, a set accelerator may comprise a trimetaphosphate. Non-limiting examples of trimetaphosphates include but are not limited to sodium, potassium or lithium salts of trimetaphosphate, such as those available from Astaris, LLC. Moreover, any amount of set accelerator not inconsistent with the technical objectives of the present disclosure may be used. For example, in some implementations, a set accelerator may be present in an amount in the range of 0.05-3.0 wt. %, 0.05-2.0 wt. %, 0.05-1.0 wt. %, 0.05-0.5 wt. %, 0.05-0.1 wt. %, 0.1-3.0 wt. %, 0.1-2.0 wt. %, 0.1-1.0 wt. %, 0.1-0.5 wt. %, 0.5-3.0 wt. %, 0.5-2.0 wt. %, 0.5-1.0 wt. %, 1.0-2.0 wt. %, 1.0-3.0 wt. %, or 2.0-3.0 wt. %, based upon the total weight of the cementitious mixture before drying.

In some cases, an additive comprises a dispersant. Any dispersant not inconsistent with the technical objectives of the present disclosure may be used. For example, in some implementations, a dispersant may comprise a polycarboxylate dispersant. Moreover, any amount of dispersant not inconsistent with the technical objectives of the present disclosure may be used. For example, in some implementations, a dispersant may be present in an amount in the range of 0.05-2.0 wt. %, based upon the total weight of the cementitious mixture before drying.

In some embodiments, an additive comprises a co-surfactant. Any co-surfactant not inconsistent with the technical objectives of the present disclosure may be used. Non-limiting examples of co-surfactants include but are not limited to alkyl polyglycosides, alkylamido betaines, glutamates, sulfoketones, sulfates, isethionates, N-acylamino acid compounds, sulfoacetates, sulfonates, sulfosuccinates, taurates, betaines, amphosurfactants, alkanolamides, amine oxides, carboxylates, alkyl ethoxylates, cationic surfactants, cationic polymers, protein hydrolyzates, silicones, fatty alcohols, protein derivatives, bleaches of disalts, and nonionic surfactants. Moreover, any amount of co-surfactant not inconsistent with the technical objectives of the present disclosure may be used. For example, in some cases, a co-surfactant may be present in an amount in the range of 0.001-1.0 wt. %, based upon the total weight of the cementitious mixture before drying.

In some cases, an additive comprises a biocide and/or anti-mold agent. Any biocide and/or anti-mold agent not inconsistent with the technical objectives of the present disclosure may be used. Non-limiting examples of biocides and/or anti-mold agents include but are not limited to boric acid, pyrithione salts, and copper salts. Moreover, any amount of biocide and/or anti-mold agent not inconsistent with the technical objectives of the present disclosure may be used. For example, in some cases, a biocide and/or anti-mold agent may be present in an amount in the range of 0.001-1.0 wt. %, based upon the total weight of the cementitious mixture before drying.

Cementitious mixtures described herein can be produced in any manner not inconsistent with the technical objectives of the present disclosure. Methods of making and curing cementitious mixtures are known in the art. In some embodiments, for instance, the components of the cementitious mixture may be blended with water to form a slurry, paste, and/or dispersion. In some implementations, the slurry, paste, and/or dispersion is poured onto a coversheet to which the slurry, paste, and/or dispersion is generally adjacent. Coversheets are known in the art. In some cases, an additional coversheet is placed on top of the slurry, paste, and/or dispersion. In some implementations, the coversheet is outwardly facing. In some embodiments, the coversheet may be decorated. For example, the coversheet may comprise paint, texture, or wallpaper.

In some instances, cementitious mixtures may be dried to heat set and/or cure the slurry, paste, and/or dispersion. Curing conditions are known in the art. In some embodiments, the cementitious mixtures are dried at ambient temperature or 45° C. for at least 24 hours or at least 48 hours.

Cementitious mixtures described herein may have particular properties when dried. For example, in some instances, a cementitious mixture described herein when dried may have a maximum flexural strength between 500 pounds and 1000 pounds, between 600 pounds and 1000 pounds, between 700 pounds and 1000 pounds, between 800 pounds and 1000 pounds, between 900 pounds and 1000 pounds, between 500 pounds and 900 pounds, between 600 pounds and 900 pounds, between 700 pounds and 900 pounds, between 800 pounds and 900 pounds, between 500 pounds and 800 pounds, between 600 pounds and 800 pounds, between 700 pounds and 800 pounds, between 500 pounds and 700 pounds, between 600 pounds and 700 pounds, or between 500 pounds and 600 pounds, according to ASTM C348-02, wherein the tested samples have not been made using a tamper and tamper guide.

Moreover, in some embodiments, a cementitious mixture described herein when dried may have a humidified deflection testing loaded distance between 4 mm and 10 mm, according to ASTM C473-03. In some cases, a cementitious mixture described herein when dried may have a humidified deflection testing loaded distance between 7 mm and 10 mm, according to ASTM C473-03. In some embodiments, a cementitious mixture described herein when dried may have a humidified deflection testing loaded distance between 4 mm and 7 mm, according to ASTM C473-03.

Additionally, in some cases, a cementitious mixture described herein when dried may have an average nail pull resistance (generally measured in pounds-force, lbf) between 70 lbf and 85 lbf, between 70 lbf and 80 lbf, between 70 lbf and 75 lbf, between 75 lbf and 85 lbf, between 75 lbf and 80 lbf, or between 80 lbf and 85 lbf, according to ASTM C473-03.

Further, in some implementations, a cementitious mixture described herein when dried may have a moisture level in the range of 1-10 wt. %, 1-8 wt. %, 1-5 wt. %, 1-3 wt. %, 3-10 wt. %, 3-8 wt. %, 3-5 wt. %, 5-10 wt. %, 5-8 wt. %, or 8-10 wt. %, based on the weight of the dried cementitious mixture.

### III. Building Materials

In yet another aspect, building materials are described herein. In some embodiments, such building materials are formed from, comprise, consists of, or consists essentially of a cementitious mixture. Any cementitious mixture described hereinabove in Section II may be used, and any flexible fiber described hereinabove in Section I may be used.

Building materials formed from, comprising, consisting of, or consisting essentially of a cementitious mixture described herein may find applications in a variety of fields, including the field of construction materials. For example, in some instances, the building materials described herein, can comprise plaster, plasterboard, gypsum board, drywall, decorative plaster, concrete, gypsum fiberboard, building plaster, plaster block, stucco, or self-leveling screed.

Building materials described herein may have particular properties. For example, in some instances, building materials described herein may have a maximum flexural strength between 500 pounds and 1000 pounds, between 600 pounds and 1000 pounds, between 700 pounds and 1000 pounds, between 800 pounds and 1000 pounds, between 900 pounds and 1000 pounds, between 500 pounds and 900 pounds, between 600 pounds and 900 pounds, between 700 pounds and 900 pounds, between 800 pounds and 900 pounds, between 500 pounds and 800 pounds, between 600 pounds and 800 pounds, between 700 pounds and 800 pounds, between 500 pounds and 700 pounds, between 600 pounds and 700 pounds, or between 500 pounds and 600 pounds, according to ASTM C348-02, wherein the tested samples have not been made using a tamper and tamper guide.

Moreover, in some embodiments, a building material described herein may have a humidified deflection testing loaded distance between 4 mm and 10 mm, according to ASTM C473-03. In some cases, a building material described herein may have a humidified deflection testing loaded distance between 7 mm and 10 mm, according to ASTM C473-03. In some embodiments, a building material described herein may have a humidified deflection testing loaded distance between 4 mm and 7 mm, according to ASTM C473-03.

Additionally, in some cases, a building material described herein may have an average nail pull resistance between 70 lbf and 85 lbf, between 70 lbf and 80 lbf, between 70 lbf and 75 lbf, between 75 lbf and 85 lbf, between 75 lbf and 80 lbf, or between 80 lbf and 85 lbf, according to ASTM C473-03.

### EXAMPLES

Some embodiments of cementitious mixtures and building materials are illustrated in the following non-limiting Examples.

### Sample Preparation

Starch Samples A-I were prepared as summarized in Table 1. Unless noted, all Samples were polypropylene fibers with linear densities of 3.3 decitex (or 3 denier; 1 denier=1.11 decitex). Table 1 identifies the linear density, inorganic component (e.g. calcium carbonate) and foaming agent.

TABLE 1
Examples

| | | | Linear | | |
|---|---|---|---|---|---|
| Starch | Cross- | Length | density | Inorganic | Foaming |
| ID | section | (mm) | (decitex) | Component | agent |
| A | Trilobal | 18 | 3.3 | Yes | Yes |
| B | Round | 12 | 3.3 | Yes | No |
| C | Round | 18 | 3.3 | Yes | Yes |
| D | Trilobal | 18 | 3.3 | Yes | Yes |
| E | Trilobal | 12 | 3.3 | Yes | Yes |
| F | Trilobal | 12 | 3.3 | Yes | No |
| G | Round | 12 | 3.3 | Yes | No |
| H | Trilobal | 12 | 3.3 | No | No |
| I | Round | 6 | 1.3 | Yes | No |

Starches A-I were pre-mixed with dry plaster, that is stucco. The dry mix was then blended with an amount of water to form a slurry. For reference purposes herein, the water to stucco ratio (WSR) is representative of the amount of water that is mixed with the dry mix equal to the mass of water over the mass of dry mix. Herein, the WSR of Samples was matched at 52 WSR for Samples A-C and 55 WSR for Samples D-I, according to the corresponding requirements.

Once the dry mix and water were blended, the slurry was measured using a slump tube to form a patty. The spread, or diameter of the patty, was measured. If the diameter was less than 7.5 inches, more dispersant was added, and if it was more than 7.5 inches, dispersant was removed. It is to be understood that 7.5 inches is a typical spread for a gypsum board slurry. A solution of 10% polynaphthalene sulfonate sodium salt (Disal®) was added as needed to match the water demand of samples with additives to the water demand of the slurry with no additives. The formulations were then used for testing the flexural strength of gypsum bars as described herein.

### Flexural Strength Testing

Flexural strength was measured on bars generated as described in Table 2. Reference bars contained no additive or contained 12 mm fiberglass having a round cross-section. Weight percents are based on the weight of the final product. Small board samples were produced using a large board mold. Target basis weights were between 1450 pounds per 1000 square feet and 1550 pounds per 1000 square feet. Commercial gypsum boards typically contain fifteen pounds of glass fibers in a one-half inch thick board with a target board weight of 1450 to 1550 pounds per 1000 square feet, or one percent. Gypsum board samples containing fifteen pounds of glass fibers or containing the calculated equivalent number of flexible fibers were used for testing.

Flexural strength tests were performed on the stucco mixtures as per ASTM C348-02 with minor modification. The method was modified in that a tamper and tamper guide were not used to make the bar specimens. The specimens were formed in a three-gang 40-millimeter by 40-millimeter by 160-millimeter (1.6 inches by 1.6 inches by 6.3 inches) mold. The bars were removed from the mold and kept at ambient conditions for seven days before they were dried to completion at 45° C. (113° F.). The wet and dry weights were recorded for each bar to determine the density. Flexural strength was measured using a flexural testing device for mortar prisms in a hydraulic press that measure the peak strength achieved. The loading rate was 10 pounds per second per ASTM C348-02.

Flexural strength measurements can be found in Table 2.

TABLE 2
Flexural strength measurements according to ASTM C348-02.

| | | | | | | | Average | Standard |
|---|---|---|---|---|---|---|---|---|
| | | | | | | Max | max | Deviation |
| | | Wet | Dry | | Average | Flexural | flexural | max |
| | | Weight | Weight | Density | Density | Strength | strength | flexural |
| Bar # | Additive | (g) | (g) | (g/mL) | (g/mL) | (pounds) | (pounds) | strength |
| 1 | No Additives- | 436.4 | 332.6 | 1.30 | 1.30 | 890 | 870 | 28 |
| 2 | stucco only | 439.1 | 334.5 | 1.30 | | 850 | | |
| 3 | 1.0 wt. % | 444.2 | 343.9 | 1.34 | 1.34 | 892 | 948 | 48 |
| 4 | Glass Fiber | 444.6 | 343.7 | 1.34 | | 978 | | |
| 5 | (12 mm) | 446.0 | 343.5 | 1.34 | | 973 | | |
| 6 | 0.4 wt. % | 435.6 | 332.7 | 1.30 | 1.29 | 855 | 921 | 65 |
| 7 | Sample A | 433.1 | 331.0 | 1.29 | | 923 | | |
| 8 | | 431.0 | 329.8 | 1.29 | | 985 | | |
| 9 | 0.4 wt. % | 437.0 | 335.1 | 1.31 | 1.31 | 875 | 893 | 57 |
| 10 | Sample B | 435.2 | 334.1 | 1.31 | | 956 | | |
| 11 | | 436.2 | 334.9 | 1.31 | | 847 | | |

Inclusion of glass fiber (Bars 3-5) increased the wet weight by 1.6 percent and increased the dry weight by 3.0 percent. Inclusion of Sample A (Bars 6-8) decreased the wet weight by 1.0 weight percent and decreased the dry weight by 0.7 percent. Inclusion of Sample B (Bars 9-11) decreased the wet weight by 0.4 percent and increased the dry weight by 0.3 percent. Bar density did not increase for bars containing Samples A and B in the same manner as for the bars containing glass fiber.

At an average of 921 pounds, the flexural strength of the bars containing Sample A increased an average of 5.9 percent compared to the reference samples with no additives, which had an average flexural strength of 870 pounds. The flexural strength of samples containing glass fibers ranged from 892 to 978 pounds, an average increase of 9.0 percent over the reference sample. The flexural strength of the samples containing Sample A overlapped measurements of the samples with glass fibers, ranging from 855 to 985 pounds. The flexural strength of the bars containing Sample B increased an average of 2.6 percent over the reference sample, with measurements ranging from 847 to 956 pounds.

However, gypsum bars containing Sample A and Sample B retained enough strength to hold the remaining one-eighth of bar thickness together, in contrast to the gypsum bars containing glass fibers, where the remainder of the bar crumbled post-test. The partially broken bars for Samples A and B were difficult to break apart the rest of the way post-test. It was observed that the fibers stretched in Sample A and Sample B, with both fiber ends remaining embedded in either side of the gypsum bar. In contrast, the glass fibers in Bars 3-5 pulled free from the gypsum bar on one side.

Polyolefin fibers of other configurations and dimensions were evaluated by the same methods. Without an inorganic filler, flexural strength was reduced up to 36.8 percent compared to the samples with inorganic fillers at the same dosage. With a smooth surface, flexural strength was reduced up to 73.1 percent compared to the samples with roughened surface at the same dosage rate. However, the fibers provided the same benefits.

Not intending to be bound by theory, it is believed while the inorganic fillers and a roughened surface created by the pores both provide benefits, the modes of action are different, such that the benefits behave synergistically and produce a favorable result that is greater than either would have alone.

### Three Point Flexural Strength

Three-point flexural strength was also measured on board samples as listed in Table 3, where board weights are reported in pounds per 1000 square feet (lb/1000 ft², also lb/msf). Reference bars contained no additive or contained 12 mm fiberglass having a round cross-section. Weight percents are based on the weight of the final product. The purpose of the three-point flexural strength test is to evaluate the three-point bending strength of a board. The test bend plane direction is across the direction of the board line, which is typically stronger because of stronger linear tensile strength.

A Shimpo Instruments FGS-500PVL test stand with a 5GV-500H force gauge and the appropriate test fittings as per ASTM standards was used for this flexural strength testing. The dimensions evaluated for this test were the ASTM dimensions, 16 inches by 12 inches, tested 14 inches on center. As per ASTM C473, longitudinal specimens were measured face down.

All three boards containing additive Samples A, B and C respectively passed the three-point flexural strength specifications compared to the specification of 110 pounds of force, as can be seen in Table 3. At 160.3 pounds of force, the three-point flexural strength of the board containing Sample A increased 24.2 percent compared to the reference sample with no additives (designated (1) in Table 3), which had a three-point flexural strength of 129.1 pounds of force. The three-point flexural strength of the board containing Sample B was 150.2 pounds of force, an increase of 16.3 percent over the reference sample. The three-point flexural strength of the board containing glass fibers was 173. Therefore, the board containing 0.4 weight percent Sample A performed almost as well as the board containing 1.0 weight percent glass fiber. Similar to results seen during flexural strength screening on gypsum bars, the boards containing Samples A and B held together when the core broke, while the samples with no additives or with glass fibers fell apart.

Reference sample (2) in Table 3 was produced using a different lot of gypsum from reference sample (1) yielding a stronger reference board—it had a three-point flexural strength of 155 pounds of force. Boards made with Samples D-I were made with the same gypsum as reference (2); a sample made with 0.4 wt. % glass fiber is provided for reference.

The board prepared with Sample H, the round fiber produced with neither calcium carbonate nor a foaming agent, produced a 4 percent lower flexural strength than reference sample (2) having no fiber additive.

The boards prepared with Sample 1 and with Sample F each produced without a foaming agent, showed improvements of 9% and 6% respectively over reference sample (2) having no fiber additive. These improvements were greater than or comparable to the board made with 0.4% glass fiber, which demonstrated a 6% improvement. All three of these samples displayed brittle behavior, with sudden fracture at the point where the test recorded flexural strength.

Without being bound by theory, it is believed that due to the smaller dimensions, Sample I (having 6 mm length fibers) and the 0.4% Fiberglass sample contained respectively 4.4 and 4.8 times the number of fibers present in Samples containing 3.3 denier fibers cut to 12 millimeters in length (e.g. Samples E-H).

Boards containing the other Samples all displayed flexible behavior, surviving well beyond the breaking stress, or flexural strength measurement. This prevents a true one-to-one comparison between these Samples and the Samples with brittle fracture patterns.

Sample D and Sample E, both trilobal fibers produced with a foaming agent, cut to 18 millimeters and 12 millimeters in length respectively, gave improvements to boards with an increase in flexural strength of 4% over the reference (2). Sample G comprising a round fiber produced without a foaming agent, yielded a board having an increase in flexural strength of 3% compared to reference (2).

As shown for brittle materials, flexural strength, or modulus of rupture, reflects the maximum bending stress the material can sustain before catastrophic failure. As shown for more flexible materials, the modulus of rupture instead reflects the degree of bending at which internal damage initiates, rather than the point of complete fracture.

Unlike brittle materials, the stress-strain curves of flexible systems exhibit a distinct yield point, at which stresses begin to redistribute internally. This was followed by the breaking stress reported by the flexural test and, subsequently, by a delayed fracture not captured by this measurement, but known to exist based upon the full stress-strain curves of the samples. As a result, while flexural strength remains a useful comparative metric, it does not fully represent the durability or service life of these samples. In some embodiments, the initial yield point can be at a 3-percent to 5-percent higher loading force than the breaking stress itself.

TABLE 3
Data from the three-point flexural strength
test according to ASTM C473.

| | Board Weight | Force (pounds | |
|---|---|---|---|
| Additive to stucco | (lbs/msf) | of force) | Increase |
| (1) No Additive | 1495 | 129 | — |
| 1.0 wt. % Glass | 1533 | 173 | 34% |
| Fiber (12 mm) | | | |
| 0.4 wt. % Sample A | 1520 | 160 | 24% |
| 0.4 wt. % Sample B | 1515 | 150 | 20% |
| 0.4 wt. % Sample C | 1527 | 155 | 20% |
| (2) No Additive | 1529 | 139 | |
| 0.4 wt. % Glass | 1531 | 147 | 6% |
| Fiber (12 mm) | | | |
| 0.4 wt. % Sample D | 1506 | 144 | 4% |
| 0.4 wt. % Sample E | 1481 | 144 | 4% |
| 0.4 wt. % Sample F | 1545 | 147 | 6% |
| 0.4 wt. % Sample G | 1511 | 143 | 3% |
| 0.4 wt. % Sample H | 1470 | 134 | −4% |
| 0.4 wt. % Sample I | 1587 | 151 | 9% |

### Humidified Deflection Testing

Commercial ceiling boards typically contain one pound of glass fiber in a one-half inch thick board. Commercial samples containing one pound of glass fiber or lab-produced samples containing the calculated equivalent number of flexible fibers were used for the humidified deflection testing. The samples used were cut to 12 inches by 24 inches.

Humidified deflection testing was performed by cutting each board in the cross direction, perpendicular to the edge. Specimens were cut no less than twelve inches away from the ends and edges of the board sample. The center of the specimen was determined, and a line drawn down length of the middle of the specimen. A large polystyrene chamber was set up with a deflection rack and a heating pad. The temperature and humidity were set on an Auber to 90° F. with a relative humidity between 87 to 93 percent. The specimens were placed on the rack face down with a one-half inch overhang on each side of the specimen. The samples remained in the chamber for 48 hours. A straight edge was placed on the sample surface, lined up with the middle of the board. The marks on the straight edge were lined up with the ends of the board specimen. A measurement was taken at the front of the middle marking on the straight edge.

Humidified deflection was measured on one-half inch board samples as defined in Table 4. By ASTM standards (ASTM C473-03), all samples passed the humidified deflection test, with no movement measured.

A modified humidified deflection test was done to determine the performance of Samples A and B as compared to glass fiber boards. The board samples remained in the humidity chamber for an additional 24 hours with a 2-kilogram or 4.4-pound load applied to the middle of each board. The results can be seen in Table 4, where board weights are reported in pounds per 1000 square feet. It was observed that when weighted, the samples with polyolefin fibers did not deflect as much as the glass fiber sample, which improved 22.2 percent over the unmodified sample. In comparison, Sample A improved 55.6 percent over the unmodified reference sample.

TABLE 4
Humidified deflection results.

| | Board | Unloaded | | Loaded |
|---|---|---|---|---|
| | Weight | Distance | | Distance |
| Sample | (lbs/msf) | (mm) | Pass/Fail | (mm) |
| No Additive | 1495 | 0 | Pass | 9 |
| 1.0 wt. % Glass Fiber | 1533 | 0 | Pass | 7 |
| 0.4 wt. % Sample A | 1515 | 0 | Pass | 4 |

Loaded measurements are of relevance, as boards used in the ceiling or sub-flooring may be required to support additional weight during and after a fire, earthquake, or other events resulting in additional weight and stress being added to the divisions between floors.

### Bending Radii Testing

One-quarter inch thick commercial samples containing fifteen pounds of glass fiber or one-half inch thick lab-produced samples comprising the calculated equivalent number of fibers as the one-quarter inch glass-containing board were used for the bending radii test. The sample size used was 9 inches wide by 16 inches long or 1.5 inches wide by 16 inches long.

Bending radii testing was performed using an 11-inch diameter jig. The back side of each board was sprayed with water to completely wet the back paper three times with a thirty-minute wait time in between. The front side was sprayed in the same manner three times with a fifteen-minute wait time in between.

A visual test to measure bending radii was conducted on: (a) a sample of one-fourth inch commercially available flex board, (b) a sample of one-half inch commercially available unmodified board, and (c) a sample of lab produced one-half inch board containing Sample A.

It was observed that when bent around a jig with a diameter of eleven inches, the one-quarter inch commercial flex board bent without the core or face paper breaking. For the regular commercial one-half inch gypsum board, it was observed that the core would break first and then the face paper would break. The board failed to bend around the pail, with cracks completely through the core immediately appearing with no bend to the board. For Sample A, it was observed that as the one-half inch board was bending, the core did not break right away. The sample bent around the jig, with only two places where the core and paper broke partially through together.

### Nail Pull Testing

Nail pull testing was performed as per ASTM C473 nail pull resistance method B. The purpose of the test is to evaluate the resistance of a board from being pulled from its fastened position in a plane normal to the plane of the board. Nail pull results reported in Table 5 are an average of six measurements tested on each gypsum board sample. The ASTM specification for one-half inch boards is 77 pounds of force.

Holes were created across the board samples three inches apart from each other. The test was conducted on one-half inch board samples identified in Table 5, where board weights are reported in pounds per 1000 square feet and nail pull resistance is measured in pounds of force (lbf, where 1 lbf (pound-force)=4.448 N (Newtons)).

Both fiber-containing samples passed specification, as can be seen in Table 4. It was found that the boards with 1.0 weight percent glass fiber and 0.4 weight percent Sample A performed the same, with improvements of 21.9 percent and 20.8 percent over the unmodified boards, respectively.

TABLE 5
Nail pull testing results.

| | | Average | Standard |
|---|---|---|---|
| | | Nail Pull | Deviation |
| | Board Weight | Resistance | Nail Pull |
| Sample | (lb/msf) | (lbf) | Resistance |
| No Additive | 1495 | 67.9 | 7.5 |
| 1.0 wt. % Glass Fiber | 1533 | 82.8 | 5.2 |
| 0.4 wt. % Sample A | 1520 | 82.0 | 1.6 |

### Water Demand Testing

Adding fibers leads to a stiffening of gypsum. To maintain a 7.5-inch target spread in a flow test, used as a measure of workability, additional water or a surfactant can be used to compensate for the stiffening effect caused by the fibers. As shown in the water demand evaluation, the amount of water needed to reach a target spread of 7.5 inches increased when adding fibers of any type. Not intending to be bound by theory, it is believed that higher water demand indicates a need for more surfactant, a better wetting agent, or a lower dosage. Water demand was measured on Samples as outlined in Table 6.

The water demand of the reference sample (1) with no additives was 52 grams per milliliter. Before the addition of a dispersant, the water demand of Sample A was 60 grams per milliliter, an increase of 15.4 percent over the reference sample. Before the addition of a dispersant, the water demand of Sample B and the glass fiber sample were both 59 grams per milliliter, an increase of 13.5 percent over the reference sample. The glass fiber sample and Sample A both required 3.0 milliliters of ten percent polynaphthalene sulfonate sodium salt under the commercial name of Disal® solution to match the water demand of the reference sample at 52 grams per milliliter. Sample B required 2.5 milliliters of ten percent Disal® solution to do the same.

TABLE 6
Water demand testing results.

| | | Water Demand | | Disal ® (10%) |
|---|---|---|---|---|
| | Fiber | before | Increase | needed to |
| | length | Dispersant | in water | reach 7.5 |
| Additives | (mm) | (g/mL) | demand | inches (mL) |
| (1) No Additives | — | 52 | — | — |
| 1.0% Glass Fiber | 12 | 59 | 13.5% | 3.0 |
| 0.4 wt. % Sample A | 18 | 60 | 15.4% | 3.0 |
| 0.4 wt. % Sample B | 12 | 59 | 13.5% | 2.5 |
| 0.4 wt. % Sample C | 18 | 60 | 15.4% | 3.0 |
| (2) No Additive | — | 55 | — | — |
| 1.0 wt. % Glass | 12 | 58 | 5.5% | 2.0 |
| Fiber (12 mm) | | | | |
| 0.4 wt. % Sample D | 18 | 61 | 10.9% | 3.5 |
| 0.4 wt. % Sample E | 12 | 58 | 5.5% | 2.0 |
| 0.4 wt. % Sample F | 12 | 58 | 5.5% | 2.0 |
| 0.4 wt. % Sample G | 12 | 58 | 5.5% | 2.0 |
| 0.4 wt. % Sample H | 12 | 63 | 14.5% | 4.5 |
| 0.4 wt. % Sample I | 6 | 62 | 12.7% | 4.0 |

The water demand of the reference sample (2) with no additives was 55 grams per milliliter. Following the trends of Samples A and B, the water demand of the eighteen-millimeter sample was higher than that of most twelve-millimeter samples. Considering all the Sample testing, six of the twelve-millimeter samples displayed a water demand increase of 5.5% over the reference sample, including the glass fiber sample. Sample H consisting solely of polypropylene containing no calcium carbonate and produced without a foaming agent had an increase in water demand of 14.5%, higher even than Sample D, the eighteen-millimeter sample, at 10.9%.

Lastly, the six-millimeter sample, Sample I, fell between the other two cut lengths (12 mm and 18 mm), with a water demand increase of 12.7% over the reference sample. Without being bound by theory, the higher level of 10% Disal used to disperse this sample (4 mL) may have positively impacted the flexural strength.

Additional exemplary embodiments contemplated herein are as follows:

Embodiment 1. A flexible fiber comprising: a polymeric component; and an inorganic component.

Embodiment 2. The flexible fiber of Embodiment 1, wherein: the surface of the flexible fiber comprises exposed pores; and at least some of the inorganic component is exposed on the surface of the flexible fiber.

Embodiment 3. The flexible fiber of Embodiment 1 or 2, wherein the polymeric component comprises a polyolefin.

Embodiment 4. The flexible fiber of any of Embodiments 1-3, wherein the polyolefin comprises a polypropylene homopolymer or copolymer.

Embodiment 5. The flexible fiber of any of Embodiments 1-4, wherein a linear density of the flexible fiber is from 0.5 decitex (dtex) to 50 dtex.

Embodiment 6. The flexible fiber of any of Embodiments 1-5, wherein the flexible fiber has a length between 2 mm and 40 mm.

Embodiment 7. The flexible fiber of any of Embodiments 1-6, wherein the flexible fiber further comprises a foaming agent.

Embodiment 8. The flexible fiber of any of Embodiments 1-7, wherein the inorganic component comprises calcium carbonate, silicon dioxide, titanium dioxide, talc, or a combination of two or more of the foregoing.

Embodiment 9. The flexible fiber of any of Embodiments 1-8, wherein the inorganic component comprises calcium carbonate.

Embodiment 10. The flexible fiber of any of Embodiments 1-9, wherein the flexible fiber has a non-circular cross-section shape.

Embodiment 11. The flexible fiber of any of Embodiments 1-10, wherein the flexible fiber has a cross-section comprising three lobes.

Embodiment 12. The flexible fiber of any of Embodiments 1-11, wherein the flexible fiber is a mono-component fiber, a bi-component fiber, or a multi-component fiber.

Embodiment 13. The flexible fiber of any of Embodiment 1-12, wherein the flexible fiber is a bi-component fiber comprising an outer layer that comprises a polyolefin component and an inorganic component.

Embodiment 14. The flexible fiber of any of Embodiments 3-13, wherein the polyolefin component comprises polypropylene, and the inorganic component is present in the flexible fiber in an amount from 1 to 30 wt. %, based on the total weight of the fiber.

Embodiment 15. The flexible fiber of any of Embodiments 1-14, wherein the flexible fiber is formed using a physical foaming extrusion method or a chemical foaming extrusion method.

Embodiment 16. The flexible fiber of any of Embodiments 1-15, wherein the surface of the flexible fiber further comprises a coating.

Embodiment 17. A cementitious mixture comprising: a cementitious material; and a flexible fiber, wherein the flexible fiber comprises: a polymeric component; and an inorganic component.

Embodiment 18. The cementitious mixture of Embodiment 17, wherein the cementitious material comprises gypsum.

Embodiment 19. The cementitious mixture of Embodiment 17 or 18, wherein: the surface of the flexible fiber comprises exposed pores; and at least some of the inorganic component is exposed on the surface of the flexible fiber.

Embodiment 20. The cementitious mixture of any of Embodiments 17-19, wherein the polymeric component comprises a polyolefin.

Embodiment 21. The cementitious mixture of Embodiment 20, wherein the polyolefin comprises a polypropylene homopolymer or copolymer.

Embodiment 22. The cementitious mixture of any of Embodiments 17-21, wherein a linear density of the flexible fiber is from 0.5 decitex (dtex) to 50 dtex.

Embodiment 23. The cementitious mixture of any of Embodiments 17-22, wherein the flexible fiber has a length between 2 mm and 40 mm.

Embodiment 24. The cementitious mixture of any of Embodiments 17-23, wherein the flexible fiber has a non-circular cross-section shape.

Embodiment 25. The cementitious mixture of any of Embodiments 17-24, wherein the flexible fiber has a cross-section comprising three lobes.

Embodiment 26. The cementitious mixture of any of Embodiments 17-25, wherein the flexible fiber is a mono-component fiber, a bi-component fiber, or a multi-component fiber.

Embodiment 27. The cementitious mixture of any of Embodiments 17-26, wherein the flexible fiber is a bi-component fiber comprising an outer layer that comprises a polyolefin component and an inorganic component.

Embodiment 28. The cementitious mixture of any of Embodiments 17-27, wherein the inorganic component comprises calcium carbonate, silicon dioxide, titanium dioxide, talc, or combinations thereof.

Embodiment 29. The cementitious mixture of any of Embodiments 20-28, wherein the polyolefin component comprises polypropylene, and the inorganic component is present in the flexible fiber in an amount from 1 to 30 wt. %, based on the total weight of the fiber.

Embodiment 30. The cementitious mixture of any of Embodiments 20-29, wherein the flexible fiber is formed using a physical foaming extrusion method or a chemical foaming extrusion method.

Embodiment 31. The cementitious mixture of any of Embodiments 20-30, wherein the surface of the flexible fiber further comprises a coating.

Embodiment 32. A building material formed from the cementitious mixture of any of Embodiments 20-31, wherein the flexible fiber is present in the cementitious mixture in an amount of 0.1 wt. % to 10 wt. %, based on the total weight of the material.

Embodiment 33. The building material of Embodiment 32, wherein the flexible fiber is present in the cementitious mixture in an amount of 0.1 wt. % to 0.5 wt. %, on the total weight of the material.

Embodiment 34. The building material of Embodiment 32 or 33, wherein the building material exhibits a maximum flexural strength between 600 and 1000 pounds as measured according to ASTM standard C348-02 with a modification of not using a tamper and tamper guide to make the samples.

All patent documents referred to herein are incorporated by reference in their entireties. Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A flexible fiber comprising:
a polymeric component; and
an inorganic component.

2. The flexible fiber of claim 1, wherein:
the surface of the flexible fiber comprises exposed pores; and
at least some of the inorganic component is exposed on the surface of the flexible fiber.

3. The flexible fiber of claim 1, wherein the polymeric component comprises a polyolefin.

4. The flexible fiber of claim 3, wherein the polyolefin comprises a polypropylene homopolymer or copolymer.

5. The flexible fiber of claim 1, wherein a linear density of the flexible fiber is from 0.5 decitex (dtex) to 50 dtex.

6. The flexible fiber of claim 1, wherein the flexible fiber has a length between 2 mm and 40 mm.

7. The flexible fiber of claim 1, wherein the flexible fiber further comprises a foaming agent.

8. The flexible fiber of claim 1, wherein the inorganic component comprises calcium carbonate, silicon dioxide, titanium dioxide, talc, or a combination of two or more of the foregoing.

9. The flexible fiber of claim 8, wherein the inorganic component comprises calcium carbonate.

10. The flexible fiber of claim 1, wherein the flexible fiber has a non-circular cross-section shape.

11. The flexible fiber of claim 10, wherein the flexible fiber has a cross-section comprising three lobes.

12. The flexible fiber of claim 1, wherein the flexible fiber is a mono-component fiber, a bi-component fiber, or a multi-component fiber.

13. The flexible fiber of claim 12, wherein the flexible fiber is a bi-component fiber comprising an outer layer that comprises a polyolefin component and an inorganic component.

14. The flexible fiber of claim 3, wherein the polyolefin component comprises polypropylene, and the inorganic component is present in the flexible fiber in an amount from 1 to 30 wt. %, based on the total weight of the fiber.

15. The flexible fiber of claim 1, wherein the flexible fiber is formed using a physical foaming extrusion method or a chemical foaming extrusion method.

16. The flexible fiber of claim 1, wherein the surface of the flexible fiber further comprises a coating.

17. A cementitious mixture comprising:
a cementitious material; and
a flexible fiber,
wherein the flexible fiber comprises:
a polymeric component; and
an inorganic component.

18. The cementitious mixture of claim 17, wherein the cementitious material comprises gypsum.

19. The cementitious mixture of claim 17, wherein:
the surface of the flexible fiber comprises exposed pores; and
at least some of the inorganic component is exposed on the surface of the flexible fiber.

20. The cementitious mixture of claim 17, wherein the polymeric component comprises a polyolefin.

21. The cementitious mixture of claim 20, wherein the polyolefin comprises a polypropylene homopolymer or copolymer.

22. The cementitious mixture of claim 17, wherein a linear density of the flexible fiber is from 0.5 decitex (dtex) to 50 dtex.

23. The cementitious mixture of claim 17, wherein the flexible fiber has a length between 2 mm and 40 mm.

24. The cementitious mixture of claim 17, wherein the flexible fiber has a non-circular cross-section shape.

25. The cementitious mixture of claim 24, wherein the flexible fiber has a cross-section comprising three lobes.

26. The cementitious mixture of claim 17, wherein the flexible fiber is a mono-component fiber, a bi-component fiber, or a multi-component fiber.

27. The cementitious mixture of claim 26, wherein the flexible fiber is a bi-component fiber comprising an outer layer that comprises a polyolefin component and an inorganic component.

28. The cementitious mixture of claim 17, wherein the inorganic component comprises calcium carbonate, silicon dioxide, titanium dioxide, talc, or combinations thereof.

29. The cementitious mixture of claim 20, wherein the polyolefin component comprises polypropylene, and the inorganic component is present in the flexible fiber in an amount from 1 to 30 wt. %, based on the total weight of the fiber.

30. The cementitious mixture of claim 17, wherein the flexible fiber is formed using a physical foaming extrusion method or a chemical foaming extrusion method.

31. The cementitious mixture of claim 17, wherein the surface of the flexible fiber further comprises a coating.

32. A building material formed from the cementitious mixture of claim 17, wherein the flexible fiber is present in the cementitious mixture in an amount of 0.1 wt. % to 10 wt. %, based on the total weight of the material.

33. The building material of claim 32, wherein the flexible fiber is present in the cementitious mixture in an amount of 0.1 wt. % to 0.5 wt. %, on the total weight of the material.

34. The building material of claim 32, wherein the building material exhibits a maximum flexural strength between 600 and 1000 pounds as measured according to ASTM standard C348-02 with a modification of not using a tamper and tamper guide to make the samples.
